(19) United States
(12) Patent Application Publication
(10) Pub. No.: US 2013/0015771 A1
(43) Pub. Date: Jan. 17, 2013

(54) LASER POINTER WITH FUNCTION OF AUTOMATICALLY ADJUSTING LIGHT INTENSITY

(71) Applicant: Yi-Guang Chen, Taipei (TW)

(72) Inventor: Yi-Guang Chen, Taipei (TW)

(73) Assignee: PRIMAX ELECTRONICS LTD., Taipei (TW)

(21) Appl. No.: 13/239,120

(22) Filed: Sep. 21, 2011

(30) Foreign Application Priority Data
Jul. 15, 2011 (TW) 100125115

(51) Int. Cl. H05B 37/02

(52) U.S. Cl. 315/158

(57) ABSTRACT

A laser pointer with a function of automatically adjusting light intensity is provided. The laser pointer includes a laser light-emitting unit, a microcontroller and a light sensing circuit. The laser light-emitting unit is used for emitting laser light. The microcontroller is electrically connected with the laser light-emitting unit. The light sensing circuit is electrically connected with the microcontroller, and includes an optical sensor for sensing an ambient luminance. A terminal voltage of the optical sensor of the light sensing circuit is detected by the microcontroller. If the terminal voltage is lower than a threshold value, the microcontroller provides a first driving voltage to the laser light-emitting unit. If the terminal voltage is higher than the threshold value, the microcontroller provides a second driving voltage to the laser light-emitting unit.

### FIELD OF THE INVENTION

The present invention relates to a laser pointer, and more particularly to a laser pointer with a function of automatically adjusting light intensity.

### BACKGROUND OF THE INVENTION

Laser pointers are presentation aids widely used in the meetings of most companies. Generally, a laser pointer is used to project a bright spot of laser light to the highlight items of interest during a presentation is made. That is, the laser pointer is a presentation aid for helping the audience well focus on the presentation contents

The current laser pointer utilizes a collimator lens to collimate the laser light and allows the laser light to be projected out through a circular outlet aperture. That is, the spot of the laser light emitted by the widely-used laser pointer usually has a circular shape. Of course, as the shape of the outlet aperture is varied, the spot of the laser light may have a different shape.

Generally, for facilitating the user to store and operate the laser pointer, the laser pointer is applied to a laser pen or an input device (e.g. a mouse). Please refer to FIG. 1, which schematically illustrates a conventional laser pen.

As shown in FIG. 1, the conventional laser pen 1 comprises a casing 11, a front cover 12, a rear cover 13, a circuit board 14 and a mercury battery 15. The circuit board 14 is disposed within the casing 11. A front end of the circuit board 14 is connected with a laser illuminator 16, which is sustained against the front cover 12. A rear end of the circuit board 14 is connected with a compression spring 17, which is sustained against the mercury battery 15. A top end of the circuit board 14 is connected with a button switch 18. When the button switch 18 is pressed down by a user, a preset circuit mounted on the circuit board 14 is conducted. Consequently, the laser illuminator 16 at the front end of the circuit board 14 emits laser light. Whereas, when the button switch 18 is no longer pressed down by the user, the preset circuit mounted on the circuit board 14 is in an open-circuited state. Under this circumstance, since the current fails to pass through the whole preset circuit, the laser illuminator 16 fails to emit laser light.

For complying with the space of the laser pen or the input device, a small-sized mercury battery is usually used as the power supply of the conventional laser pointer. Since the mercury battery has low power capability, the use of the laser pointer is readily suffered from a power shortage problem. Under this circumstance, it is necessary to replace the mercury battery. Moreover, regardless of whether the ambient luminance is strong or weak, the laser illuminator of the conventional laser pointer always output the same lighting power. That is, the intensity of the laser light emitted by the laser pointer is constant. However, in a case that the laser pointer is used in a dim environment, a low output power of the laser illuminator is sufficient to make the spot of the laser light clearly visible by the audience.

Therefore, there is a need of providing a laser pointer capable of automatically adjusting the intensity of the laser light according to the ambient luminance in order to save power consumption.

### SUMMARY OF THE INVENTION

The present invention provides a laser pointer capable of automatically adjusting the intensity of the laser light according to the ambient luminance.

The present invention also provides a power-saving laser pointer.

In accordance with an aspect of the present invention, there is provided a laser pointer with a function of automatically adjusting light intensity. The laser pointer includes a laser light-emitting unit, a microcontroller and a light sensing circuit. The laser light-emitting unit is used for emitting laser light. The microcontroller is electrically connected with the laser light-emitting unit. The light sensing circuit is electrically connected with the microcontroller, and includes an optical sensor for sensing an ambient luminance. A terminal voltage of the optical sensor of the light sensing circuit is detected by the microcontroller. If the terminal voltage is lower than a threshold value, the microcontroller provides a first driving voltage to the laser light-emitting unit. Whereas, if the terminal voltage is higher than the threshold value, the microcontroller provides a second driving voltage to the laser light-emitting unit.

In an embodiment, a pulse width of the first driving voltage is different from a pulse width of the second driving voltage.

In an embodiment, the light sensing circuit includes a power terminal, a resistor and the optical sensor. The resistor is electrically connected with the power terminal. The optical sensor is used for sensing the ambient luminance, wherein an end of the optical sensor is connected with the resistor in series.

In an embodiment, the terminal voltage at the end of the optical sensor connected with the resistor in series is detected by the microcontroller.

In an embodiment, the optical sensor is a photoresistor.

In an embodiment, the pulse width of the second driving voltage is greater than the pulse width of the first driving voltage.

In an embodiment, the optical sensor is a photodiode.

In an embodiment, the pulse width of the second driving voltage is smaller than the pulse width of the first driving voltage.

In an embodiment, the laser pointer is included in a presenter.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional laser pen;

FIG. 2 is a schematic circuit diagram illustrating a laser pointer with a function of automatically adjusting light intensity according to a first embodiment of the present invention;

FIG. 3 is a schematic timing waveform diagram illustrating the first driving voltage produced by the laser pointer according to the first embodiment of the present invention;

FIG. 4 is a schematic timing waveform diagram illustrating the second driving voltage produced by the laser pointer according to the first embodiment of the present invention;

FIG. 5 is a schematic circuit diagram illustrating a laser pointer with a function of automatically adjusting light intensity according to a second embodiment of the present invention;

FIG. 6 is a schematic timing waveform diagram illustrating the third driving voltage produced by the laser pointer according to the second embodiment of the present invention; and

FIG. 7 is a schematic timing waveform diagram illustrating the fourth driving voltage produced by the laser pointer according to the second embodiment of the present invention.

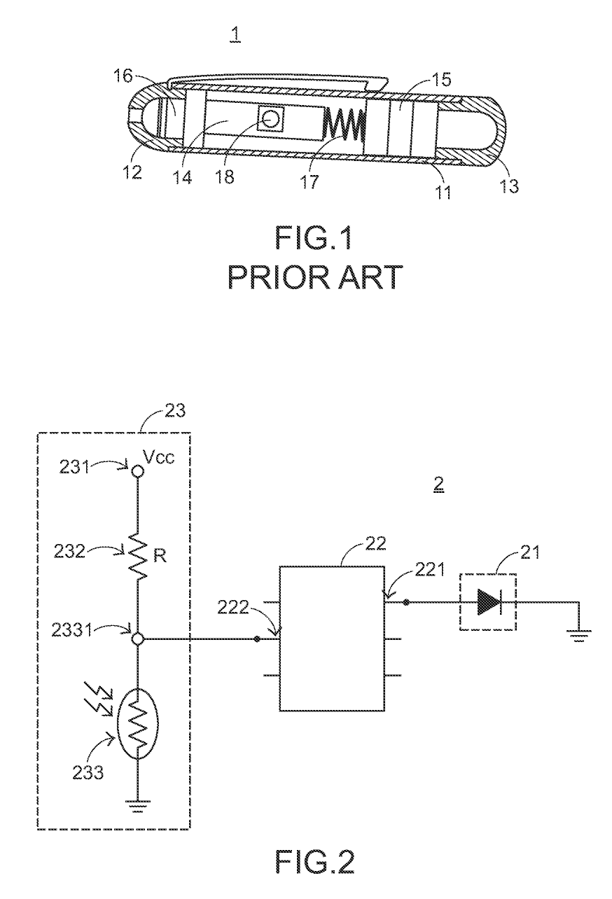

### DETAILED DESCRIPTION OF THE PREFERRED EMBODIMENT

FIG. 2 is a schematic circuit diagram illustrating a laser pointer with a function of automatically adjusting light intensity according to a first embodiment of the present invention. As shown in FIG. 2, the laser pointer 2 comprises a laser light-emitting unit 21, a microcontroller 22 and a light sensing circuit 23. The laser light-emitting unit 21 is used for emitting laser light. In this embodiment, the laser light-emitting unit 21 is a laser diode. The laser light-emitting unit 21 and the light sensing circuit 23 are electrically connected with a first control port 221 and a second control port 222 of the microcontroller 22. The light sensing circuit 23 comprises a power terminal 231, a resistor 232 and an optical sensor 233. The resistor 232 is electrically connected with the power terminal 231. An end 2331 of the optical sensor 233 is connected with the resistor 232 and the second control port 222 in series. In addition, the optical sensor 233 is used for sensing the ambient luminance.

In this embodiment, the optical sensor 233 is a well-known photoresistor whose resistance decreases with increasing incident light intensity. That is, as the light intensity is increased, the resistance of the photoresistor is decreased. On the other hand, as the light intensity is decreased, the resistance of the photoresistor is increased.

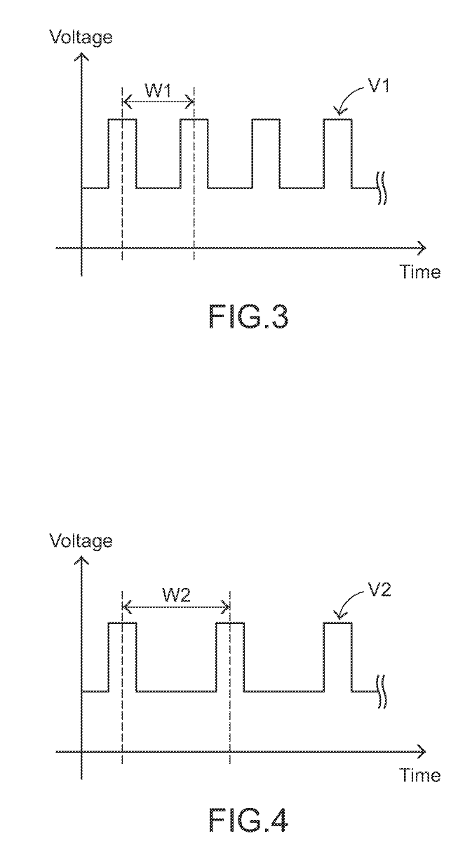

Hereinafter, a method of enabling the laser pointer will be illustrated by referring to a high ambient luminance situation and a low ambient luminance situation. In a case that the laser pointer 2 of the present invention is used in a bright place (i.e. the laser pointer 2 of the present invention is operated in the high ambient luminance situation), the resistance of the optical sensor 233 is decreased. Meanwhile, a low terminal voltage at the end 2331 of the optical sensor 233 is detected by the second control port 222 of the microcontroller 22. If the terminal voltage at the end 2331 of the optical sensor 233 is lower than a threshold value because of the ambient luminance, the microcontroller 22 provides a first driving voltage V1 to the laser light-emitting unit 21 through the first control port 221. Please refer to FIG. 3, which is a schematic timing waveform diagram illustrating the first driving voltage V1 produced by the laser pointer according to the first embodiment of the present invention. In FIG. 3, the horizontal axis denotes time, and the vertical axis denotes voltage.

Whereas, in a case that the laser pointer 2 of the present invention is used in a dim place (i.e. the laser pointer 2 of the present invention is operated in the low ambient luminance situation), the resistance of the optical sensor 233 is increased. Meanwhile, a high terminal voltage at the end 2331 of the optical sensor 233 is detected by the second control port 222 of the microcontroller 22. If the terminal voltage at the end 2331 of the optical sensor 233 is higher than the threshold value because of the ambient luminance, the microcontroller 22 provides a second driving voltage V2 to the laser light-emitting unit 21 through the first control port 221. Please refer to FIG. 4, which is a schematic timing waveform diagram illustrating the second driving voltage V2 produced by the laser pointer according to the first embodiment of the present invention.

Please refer to FIGS. 3 and 4. It is noted that the pulse width W1 of the first driving voltage V1 is different from the pulse width W2 of the second driving voltage V2. In this embodiment, the pulse width W2 of the second driving voltage V2 is greater than the pulse width W1 of the first driving voltage V1. That is, in a case that the laser pointer 2 of the present invention is used in a bright place, the first driving voltage V1 is received by the laser light-emitting unit 21. Since the pulse width W1 of the first driving voltage V1 is narrower, the pulse frequency of the first driving voltage V1 outputted from the microcontroller 22 and received by the laser light-emitting unit 21 in unit time is higher than the pulse frequency of the second driving voltage V2. Under this circumstance, the output power of the laser light-emitting unit 21 is higher, and thus the intensity of the laser light emitted by the laser pointer 2 is stronger. Since the intensity of the laser light is stronger, even if the laser pointer 2 is operated in the high ambient luminance situation, the spot of laser light projected from the laser pointer 2 is still clearly visible.

Whereas, in a case that the laser pointer 2 of the present invention is operated in the low ambient luminance situation, the second driving voltage V2 is received by the laser light-emitting unit 21. Since the pulse width W2 of the second driving voltage V2 is wider, the pulse frequency of the second driving voltage V2 outputted from the microcontroller 22 and received by the laser light-emitting unit 21 in unit time is lower than the pulse frequency of the first driving voltage V1. Under this circumstance, the output power of the laser light-emitting unit 21 is lower, and thus the intensity of the laser light emitted by the laser pointer 2 is weaker. However, since the laser pointer 2 is used in the low ambient luminance situation, the spot of laser light projected from the laser pointer 2 is still clearly visible. Moreover, since the output power of the laser light-emitting unit 21 is lower, a power-saving purpose is achievable.

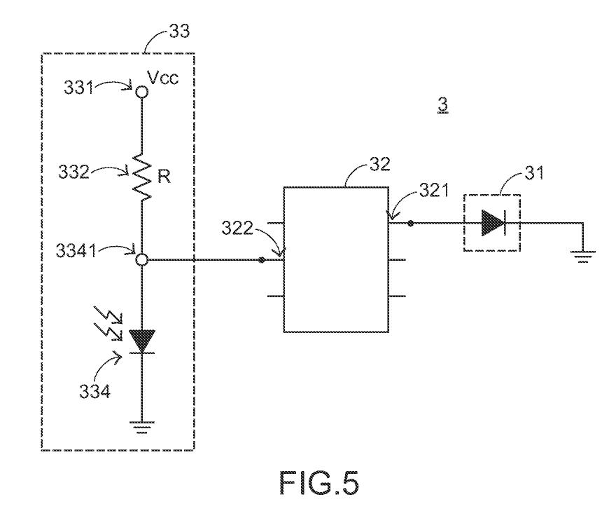

FIG. 5 is a schematic circuit diagram illustrating a laser pointer with a function of automatically adjusting light intensity according to a second embodiment of the present invention. As shown in FIG. 5, the laser pointer 3 comprises a laser light-emitting unit 31, a microcontroller 32 and a light sensing circuit 33. In this embodiment, the light sensing circuit 33 comprises a power terminal 331, a resistor 332 and an optical sensor 334. The resistor 332 is electrically connected with the power terminal 331. An end 3431 of the optical sensor 334 is connected with the resistor 332 and the second control port 322 of the microcontroller 32 in series. In addition, the optical sensor 334 is used for sensing the ambient luminance.

The circuit of this embodiment is substantially identical to that of the first embodiment except that the optical sensor 334 is a general photodiode. If the light intensity exceeds a certain level, the photodiode is conducted. Depending on the type of the photodiode, the certain level is varied. Whereas, if the light intensity is lower than the certain level, the photodiode is shut off (i.e. in an open-circuited state).

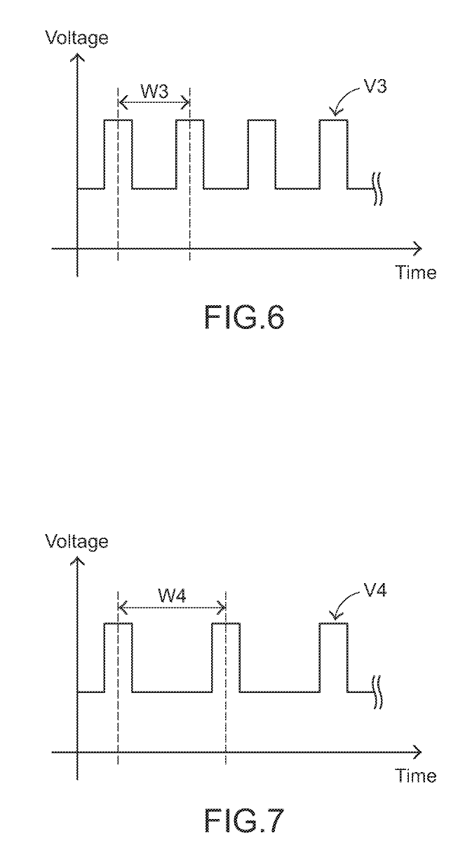

Hereinafter, a method of enabling the laser pointer will be illustrated by referring to a high ambient luminance situation and a low ambient luminance situation. In a case that the laser pointer 3 of the present invention is used in a bright place, the optical sensor 334 is conducted because of the high ambient luminance. Moreover, due to the voltage drop across both ends of the optical sensor 334, a terminal voltage at the end 3341 of the optical sensor 334 higher than a threshold voltage is detected by the second control port 322 of the microcontroller 32. When the terminal voltage at the end 3341 of the optical sensor 334 is higher than the threshold value, the microcontroller 32 provides a third driving voltage V3 to the laser light-emitting unit 31 through the first control port 321. Please refer to FIG. 6, which is a schematic timing waveform diagram illustrating the third driving voltage V3 produced by the laser pointer according to the second embodiment of the present invention. In FIG. 6, the horizontal axis denotes time, and the vertical axis denotes voltage.

Whereas, in a case that the laser pointer 2 of the present invention is used in a dim place (i.e. in the low ambient luminance situation), the optical sensor 334 is shut off. Consequently, a terminal voltage at the end 3341 of the optical sensor 334 lower than the threshold voltage is detected by the second control port 322 of the microcontroller 32. When the terminal voltage at the end 3341 of the optical sensor 334 is lower than the threshold value, the microcontroller 32 provides a fourth driving voltage V4 to the laser light-emitting unit 31 through the first control port 321. Please refer to FIG. 7, which is a schematic timing waveform diagram illustrating the fourth driving voltage V4 produced by the laser pointer according to the second embodiment of the present invention.

Please refer to FIGS. 6 and 7. In this embodiment, the pulse width W4 of the fourth driving voltage V4 is greater than the pulse width W3 of the third driving voltage V3. That is, in a case that the laser pointer 3 of the present invention is operated in the high ambient luminance situation, the third driving voltage V3 is received by the laser light-emitting unit 21. Since the pulse width W3 of the third driving voltage V3 is narrower, the pulse frequency of the third driving voltage V3 outputted from the microcontroller 32 and received by the laser light-emitting unit 31 in unit time is higher than the pulse frequency of the fourth driving voltage V4. Under this circumstance, the output power of the laser light-emitting unit 31 is higher, and thus the intensity of the laser light emitted by the laser pointer 3 is stronger. Since the intensity of the laser light is stronger, even if the laser pointer 3 is operated in the high ambient luminance situation, the spot of laser light projected from the laser pointer 3 is still clearly visible.

Whereas, in a case that the laser pointer 3 of the present invention is operated in the low ambient luminance situation, the fourth driving voltage V4 is received by the laser light-emitting unit 31. Since the pulse width W4 of the fourth driving voltage V4 is wider, the pulse frequency of the fourth driving voltage V4 outputted from the microcontroller 32 and received by the laser light-emitting unit 31 in unit time is lower than the pulse frequency of the third driving voltage V3. Under this circumstance, the output power of the laser light-emitting unit 31 is lower, and thus the intensity of the laser light emitted by the laser pointer 3 is weaker. However, since the laser pointer 3 is operated in the low ambient luminance situation or used in the dim place, the spot of laser light projected from the laser pointer 3 is still clearly visible. Moreover, since the output power of the laser light-emitting unit 31 is lower, a power-saving purpose is achievable.

In the above embodiment, the present invention provides a laser pointer with a function of automatically adjusting light intensity. The laser pointer can be applied to and included in a laser pen, a presenter or any other input device (e.g. a mouse). It is noted that the optical sensor of the laser pointer of the present invention should be installed at a position capable of sensing the ambient luminance.

From the above description, the laser pointer of the present invention is capable of automatically adjusting the intensity of the laser light and saving power consumption by means of the optical sensor and microcontroller.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laser pointer with a function of automatically adjusting light intensity, said laser pointer comprising:
a laser light-emitting unit for emitting laser light;
a microcontroller electrically connected with said laser light-emitting unit; and
an light sensing circuit electrically connected with said microcontroller, and comprising an optical sensor for sensing an ambient luminance, wherein a terminal voltage of said optical sensor of said light sensing circuit is detected by said microcontroller, wherein if said terminal voltage is lower than a threshold value, said microcontroller provides a first driving voltage to said laser light-emitting unit, wherein if said terminal voltage is higher than said threshold value, said microcontroller provides a second driving voltage to said laser light-emitting unit.

2. The laser pointer according to claim 1 wherein a pulse width of said first driving voltage is different from a pulse width of said second driving voltage.

3. The laser pointer according to claim 1 wherein said light sensing circuit comprises:
a power terminal;
a resistor electrically connected with said power terminal; and
said optical sensor for sensing said ambient luminance, wherein an end of said optical sensor is connected with said resistor in series.

4. The laser pointer according to claim 3 wherein said terminal voltage at said end of said optical sensor connected with said resistor in series is detected by said microcontroller.

5. The laser pointer according to claim 3 wherein said optical sensor is a photoresistor.

6. The laser pointer according to claim 5 wherein said pulse width of said second driving voltage is greater than said pulse width of said first driving voltage.

7. The laser pointer according to claim 3 wherein said optical sensor is a photodiode.

8. The laser pointer according to claim 7 wherein said pulse width of said second driving voltage is smaller than said pulse width of said first driving voltage.

9. The laser pointer according to claim 1 wherein said laser pointer is included in a presenter.
